(19) United States
(12) Patent Application Publication
(10) Pub. No.: US 2012/0170264 A1
(43) Pub. Date: Jul. 5, 2012

(54) OMNISPECTRUM LED GROW LIGHT

(76) Inventors: Cammie McKenzie, Santa Clarita, CA (US); Julie E. McKenzie, Santa Clarita, CA (US)

(21) Appl. No.: 13/342,774

(22) Filed: Jan. 3, 2012

Related U.S. Application Data
(60) Provisional application No. 61/429,311, filed on Jan. 3, 2011.

(51) Int. Cl. F21V 9/00

(52) U.S. Cl. 362/231

(57) ABSTRACT

An omnispectrum LED grow light is disclosed. Features of the light may include, inter alia, a plurality of LED elements including a plurality of different LED types, each LED type having a unique light wavelength output. The LED elements may be distributed across a grow light surface. A controller may be configured to adjust the intensities of the omnispectrum LED grow light at each of the light wavelengths. The controller may provide a plurality of settings that are configured to automatically adjust multiple intensities to a level that is optimized for a particular plant or growth phase. The controller may also be configured to allow independent control over the intensities of individual light wavelengths.

### CROSS-REFERENCE TO RELATED APPLICATIONS

Priority is claimed to U.S. Provisional Application 61/429,311, entitled “OMNISPECTRUM LED GROW LIGHT”, filed on Jan. 3, 2010 and identified by attorney docket number HYDRO000400, which is incorporated herein by reference.

### BACKGROUND

Light Emitting Diode (LED) technology has made significant gains in recent years. The efficiency and light output of LED's has increased exponentially since the 1960's, with a doubling occurring about every 36 months. As a result, LED technology can now be successfully deployed for grow light applications, to provide high-efficiency, low cost, safe and long-lasting grow light solutions. However, today's LED grow lights provide a “one size fits all” light output. There is a need in the industry for LED grow lights that can be effectively adapted for the different light needs of different plant species, and for the different light needs of plants at different phases of growth.

### SUMMARY

An omnispectrum LED grow light is disclosed. Features of the light may include, inter alia, a plurality of LED elements including a plurality of different LED types, each LED type having a unique light wavelength output. The LED elements may be distributed across a grow light surface. A controller may be configured to adjust the intensities of the omnispectrum LED grow light at each of the light wavelengths. The controller may provide a plurality of settings that are configured to automatically adjust multiple intensities to a level that is optimized for a particular plant or growth phase. The controller may also be configured to allow independent control over the intensities of individual light wavelengths. Further aspects and embodiments are described below.

### BRIEF DESCRIPTION OF THE DRAWINGS

FIG. 1 illustrates side and bottom views of an example omnispectrum LED grow light.

FIG. 2 illustrates an example controller User Interface (UI) for an omnispectrum LED grow light.

FIG. 3 illustrates an example controller architecture for an omnispectrum LED grow light.

FIG. 4 illustrates another example controller UI for an omnispectrum LED grow light.

FIG. 5 illustrates another example controller UI for an omnispectrum LED grow light.

FIG. 6 illustrates an LED element and grow areas produced by acute angle lenses.

### DETAILED DESCRIPTION

The illustrative embodiments provided herein are not meant to be limiting. Other embodiments may be utilized, and changes may be made, without departing from the spirit or scope of the subject matter presented here. It will be understood that aspects of the present disclosure may be arranged, substituted, combined, and designed in a wide variety of different configurations.

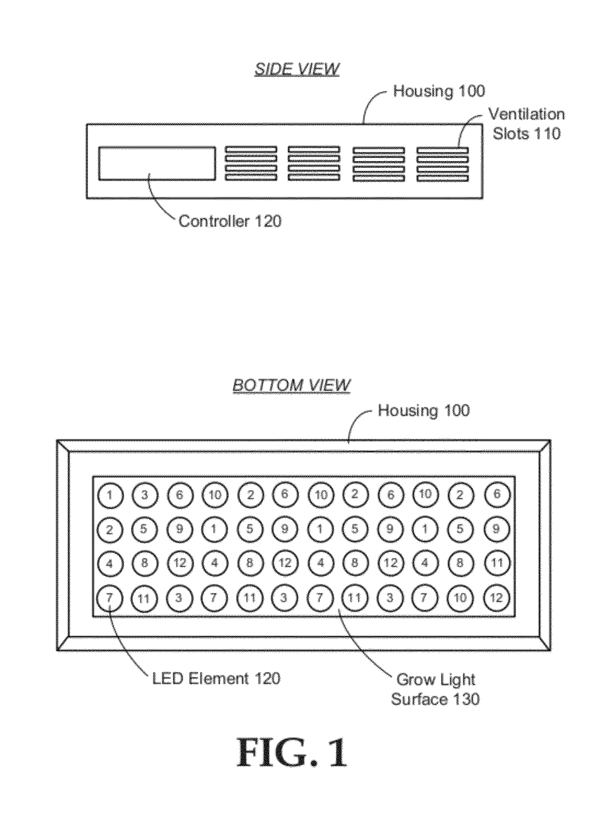

FIG. 1 illustrates side and bottom views of an example omnispectrum LED grow light. The side view shows a housing 100 with ventilation slots 110 allowing for cooling the grow light during operation, and an opening in the housing 100 for accessing a controller 120. The bottom view shows the housing 100 and a plurality of LED elements 120 on a grow light surface 130. The LED elements 120 are labeled with LED type numbers from 1-12, each LED type number representing a unique LED output wavelength or unique combination of multiple output wavelengths. For example, in some embodiments, the LED type numbers 1-12 may represent the output wavelengths shown below in TABLE 1, measured in nanometers (nm) or Kelvin (K). The LED type 12, with an output of 4500K, is an example of an LED type that outputs a unique combination of multiple output wavelengths.

TABLE 1

| LED Type | Wavelength(s) |
|---|---|
| 1 | 420 nm |
| 2 | 440 nm |
| 3 | 450 nm |
| 4 | 460 nm |
| 5 | 470 nm |
| 6 | 612 nm |
| 7 | 630 nm |
| 8 | 640 nm |
| 9 | 660 nm |
| 10 | 670 nm |
| 11 | 740 nm |
| 12 | 4500K |

It will be appreciated that the wavelength(s) associated with the above LED types, as well as the number of different LED types used, and the arrangement of the different LED types on the grow light surface 130 may vary according to design requirements as well as aesthetic preferences in some embodiments. In general, the omnispectrum LED grow light in FIG. 1 comprises a plurality of LED elements of a first wavelength, e.g., the LED elements of LED type 1, arranged on a grow light surface 130, and a plurality of LED elements of a second wavelength, e.g., the LED elements of LED type 2, arranged on the grow light surface 130, optionally along with LED elements of a plurality of additional wavelengths, e.g., the LED elements of LED types 3-12, also arranged on the grow light surface 130.

In one example embodiment, an omnispectrum LED grow light may comprise a first number of LEDs, e.g., 199 one-watt LEDs, arranged on a board designed for a larger number of LEDs, e.g., 288 LEDs, or roughly twice the first number of LEDs. In some embodiments, all of the LEDs may comprise acute angle lenses, such as 60° lenses, as described herein. This disclosure is not limited to the above number, spacing, and lens type, and other embodiments may be configured differently.

Furthermore, an example omnispectrum LED grow light may include ratios of LED types similar to the following: eight 420 nm LEDs, eight 440 nm LEDs, eight 450 nm LEDs, eight 460 nm LEDs, eight 470 nm LEDs, twenty four 612 nm LEDs, twenty four 630 nm LEDs, twenty four 640 nm LEDs, twenty four 660 nm LEDs, twenty four 670 nm LEDs, twenty four 740 nm LEDs, and fifteen 4500 Kelvin (K) LEDs. Twelve adjustment dials may be provided, to allow for individually adjusting the intensity of LED elements of each LED type. This disclosure is not limited to the above numbers and ratios of LED types, or number or configuration of the adjustment mechanisms, and other embodiments may be configured differently. In some embodiments, a light may comprise approximately 4.8% wavelengths in the 430-450 nm range, 4.8% wavelengths in the 460-480 nm range, 19% wavelengths in the 630-650 nm range, 57.1% wavelengths in the 650-670 nm range, 9.5% wavelengths in the 730-750 nm range, and 4.8% multi-wavelength white light LEDs in the 4500K-6500K range. In some embodiments, a light may comprise approximately 75% red light between 600-700 nm, 15% blue light in the 400-500 nm range, and 10% green light between 500-600 nm.

In some embodiments an example omnispectrum LED grow light may include LED elements 120 comprising any combination of the below listed output wavelengths:

TABLE 2

| LED Type | Wavelength(s) |
|---|---|
| A | 365 nm |
| B | 390 nm |
| C | 410 nm |
| D | 420 nm |
| E | 440 nm |
| F | 450 nm |
| G | 460 nm |
| H | 470 nm |
| I | 525 nm |
| J | 580 nm |
| K | 612 nm |
| L | 620 nm |
| M | 630 nm |
| N | 640 nm |
| O | 660 nm |
| P | 670 nm |
| Q | 740 nm |
| R | 3000K |
| S | 4500K |
| T | 6000K |

In some embodiments an example omnispectrum LED grow light may include LED elements 120 comprising a customer-selected combination output wavelengths. A customer selected combination may comprise a subset of the above listed output wavelengths. The numbers of LED elements 120 at each selected wavelength may also be customer-selected in some embodiments.

In some embodiments an example omnispectrum LED grow light may include LED elements 120 comprising a subset of the above listed output wavelengths including 11-13 different wavelengths. Any numbers of LED elements 120 may be included at each wavelength in the subset.

In some embodiments an example omnispectrum LED grow light may include one or more “light engines”. Light engines are described in U.S. patent application Ser. No. 13/189,009, filed Jul. 22, 2011, entitled “High Performance LED Grow Light”, which is incorporated herein by reference. In general a light engine may include a group of LED elements 120. A light engine may comprise a predetermined number of LED elements 120, arranged in a predetermined spatial pattern, and with a predetermined color (output wavelength) pattern. For example, a light engine may comprise 21 LED elements, arranged in 5 rows, with 3 LED elements in each of the top and bottom rows, and 5 LED elements arranged in each of 3 middle rows. A light engine may comprise a subset of the above listed output wavelengths including, e.g., 7 different wavelengths. Any numbers of LED elements 120 may be included at each wavelength in the subset.

In some embodiments the controller 120 may be configured to automatically adjust multiple intensities of the omnispectrum LED grow light. The term “automatic” refers to a process not requiring human action beyond an initial action to start the automatic process. For example, after initial user selection of a setting, an automatic process may adjust multiple intensities of the omnispectrum LED grow light without further user action. The term “multiple intensities” refers to intensities of an omnispectrum LED grow light at two, three, four, five, or more different wavelengths, up to the twelve wavelengths illustrated in TABLE 1, and optionally additional wavelengths, such as those listed in TABLE 2, if more wavelengths are provided in a particular omnispectrum LED grow light. In some embodiments, the controller 120 may be configured to automatically and simultaneously adjust multiple intensities. In some embodiments, the controller 120 may be configured to automatically and serially adjust multiple intensities.

In some embodiments the controller 120 may also be configured to independently adjust single intensities of an omnispectrum LED grow light. For example, a controller 120 may provide UI allowing a user to select a wavelength/LED type provided by an omnispectrum LED grow light, and to independently adjust the intensity thereof. In response to user adjustment of a selected wavelength, the controller 120 may be configured to independently adjust the selected wavelength of the omnispectrum LED grow light without also adjusting the other wavelengths/LED types provided by the omnispectrum LED grow light.

It will be appreciated that in addition to the elements illustrated in FIG. 1, an omnispectrum LED grow light may also include a variety of standard elements such as a power cord and cooling fans.

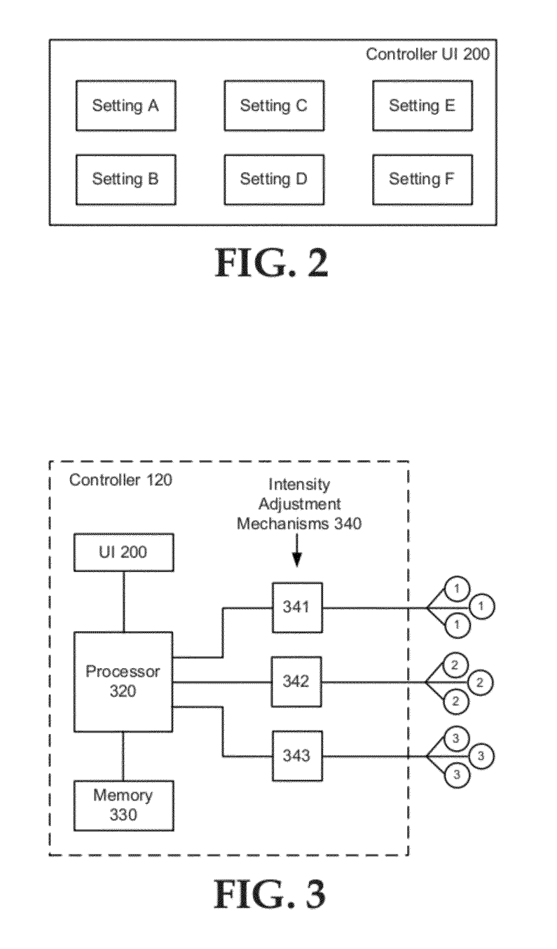

FIG. 2 illustrates an example controller User Interface (UI) for an omnispectrum LED grow light. The UI 200 may be provided for example by a touch screen, allowing user selection of the elements of the UI 200 by touching an appropriate UI element. The UI 200 comprises a plurality of selectable settings, e.g., setting A, B, C, D, E, and F. Each of the plurality of settings may correspond to a plant type and/or plant growth phase, so that selection of a setting from the plurality of settings causes the controller 120 to automatically adjust the intensity of the LED grow light at the first and second wavelengths, as well as optionally also automatically adjusting the intensities of any of the other wavelengths provided by the LED grow light, to optimal intensity levels for the plant type and/or growth phase corresponding to the selected setting.

The automatic adjusting by the controller 120 may comprise for example upwardly or downwardly adjusting intensities of any of the wavelengths. It is possible, but not necessary that intensities of all wavelengths are adjusted in a same direction and/or by a same amount. In some embodiments, intensities of one or more wavelengths may be adjusted up, while intensities of one or more other wavelengths may be adjusted down. In some embodiments, intensities of one or more wavelengths may be adjusted up or down by some first amount, while intensities of one or more wavelengths may be adjusted up or down by some second amount. In some embodiments, intensities of each of the various wavelengths in a light may be adjusted independently to a level identified in a stored setting.

In some embodiments, for example, setting A may correspond to a germination phase of tomatoes of a first type, while setting B corresponds to a growth phase of tomatoes of the first type, and setting C corresponds to a flowering phase of tomatoes of the first type. Setting D may correspond to a germination phase of tomatoes of a second type, while setting E corresponds to a growth phase of tomatoes of the second type, and setting F corresponds to a flowering phase of tomatoes of the second type. In response to a selection in the UI 200 of one of the settings A-F, the controller 120 may be configured to automatically adjust the intensity of the various wavelengths of the LED grow light to optimal intensity levels for the plant type and/or growth phase corresponding to the selected setting.

In another example, setting A may correspond to a germination phase, while setting B corresponds to a growth phase, setting C corresponds to a flowering phase, and so on, where each setting corresponds to a different growth phase. In response to a selection in the UI 200 of one of the settings A-F, the controller 120 may be configured to automatically adjust the intensity of the various wavelengths of the LED grow light to optimal intensity levels for the or growth phase corresponding to the selected setting.

In another example, setting A may correspond to tomatoes, while setting B corresponds to lettuce, setting C corresponds alfalfa sprouts, and so on, where each setting corresponds to a different plant species. In response to a selection in the UI 200 of one of the settings A-F, the controller 120 may be configured to automatically adjust the intensity of the various wavelengths of the LED grow light to optimal intensity levels for the plant type corresponding to the selected setting. A controller memory may be configured with stored settings reflecting optimal intensity levels for various species and/or growth phases, which settings may be based on scientifically tested plant growth data and/or plant growth theory.

In some embodiments, the UI 200 may be provided for example by hardware other than a touch screen, for example, by a Liquid Crystal Display (LCD) or other display type, accompanied by hardware buttons proximal to the UI 200. The hardware buttons may be configured to allow user navigation among the UI elements as well as selection of UI elements provided in the display. In some embodiments, aspects of the UI 200 may further comprise menus or selectable navigation buttons for navigating forward and backward from the UI 200, to and from different UIs as may be provided by the controller 120, for the purpose of controlling other aspects of the omnispectrum LED grow light and/or retrieving information from the omnispectrum LED grow light.

In some embodiments, one or more of the settings A, B, C, D, E, and F provided by the UI 200 may be programmed at the factory to implement one or more pre-configured settings. In some embodiments, one or more of the settings A, B, C, D, E, and F provided by the UI 200 may be user-programmable to implement one or more custom settings. A UI may comprise UI elements for indicating user intent to program a setting, and for inputting custom setting values.

FIG. 3 illustrates an example controller architecture for an omnispectrum LED grow light. In general, the controller 120 may comprise a computer, various elements of which are illustrated in FIG. 3. FIG. 3 illustrates a controller 120 comprising a processor 320, memory 330, UI 200, and intensity adjustment mechanisms 340, comprising example mechanisms 341, 342, and 343. The processor 320 is coupled to the UI 200, the memory 330, and each of the example intensity adjustment mechanisms 341, 342, 343.

In FIG. 3, each of the intensity adjustment mechanisms 341, 342, 343 is coupled to LED elements of a LED type listed in TABLE 1. An intensity adjustment mechanism 341 is coupled to the plurality of LED elements of a first wavelength, e.g., a plurality of LED elements of LED type 1, and intensity adjustment mechanism 341 is configured for adjusting the intensity of the omnispectrum LED grow light at the first wavelength. An intensity adjustment mechanism 342 is coupled to the plurality of LED elements of a second wavelength, e.g., a plurality of LED elements of LED type 2, and intensity adjustment mechanism 342 is configured for adjusting the intensity of the omnispectrum LED grow light at the second wavelength. An intensity adjustment mechanism 343 is coupled to the plurality of LED elements of a third wavelength, e.g., a plurality of LED elements of LED type 3, and intensity adjustment mechanism 343 is configured for adjusting the intensity of the omnispectrum LED grow light at the third wavelength. Additional intensity adjustment mechanisms may be included, for any of the various wavelengths provided by a particular omnispectrum LED grow light. For example, an LED grow light such as illustrated in FIG. 1 may comprise up to twelve intensity adjustment mechanisms, one for each of the LED types listed in TABLE 1. An LED grow light comprising one or more light engines as described herein may comprise a number of intensity adjustment mechanisms corresponding to a number of different wavelengths included in a light engine design, e.g., 7 intensity adjustment mechanisms in some embodiments.

In FIG. 3, the processor 320 may be configured to communicate with the UI 200 for example by providing graphics for display on the UI 200, and receiving setting selections from the UI 200.

Memory 330 may comprise a plurality of sets of intensity values, each set of intensity values corresponding to a setting selection available in the UI 200. Each set of intensity values may comprise an intensity value for each of the intensity adjustment mechanisms 340. Upon receiving a setting selection from UI 200, the processor 320 may be configured to automatically look up a corresponding set of intensity values in the memory 330.

The intensity adjustment mechanisms 340 may be implemented by any of a variety of electronic components, as will be appreciated, including for example variable resistors, integrated circuits, and/or other electronic components. In some embodiments, the intensity adjustment mechanisms 340 may be configured to adjust the electrical power supplied to LED elements, thereby adjusting the intensity of the LED elements. In some embodiments, the intensity adjustment mechanisms 340 may be configured to adjust the number of LED elements that are illuminated, wherein an increased number of illuminated LED elements provides increased intensity at the corresponding wavelength, and vice versa. In some embodiments, the intensity adjustment mechanisms 340 may be configured to illuminate LED elements of higher or lower intensity, e.g., LED elements with higher intensity, acute angle lenses or LED elements with lower intensity, wide angle lenses, in order to adjust the intensity.

The processor 320 may be configured to automatically apply a retrieved set of intensity values to a plurality of the intensity adjustment mechanisms 340. In some embodiments, each of the intensity adjustment mechanisms 341, 342, 343 may be coupled to the processor 320 on a different control channel, allowing the processor 320 to automatically and simultaneously adjust a plurality of the intensity adjustment mechanisms 341, 342, 343 by setting them to intensity levels specified in the set of intensity values retrieved from the memory 330. The processor 320 may be configured to control the intensity adjustment mechanisms 340 for example by sending one or more intensity adjustment control signals to one or more of the intensity adjustment mechanisms 340, causing the intensity adjustment mechanisms 340 to adjust the intensity of the LED elements as specified in the intensity adjustment control signals.

In some embodiments, the processor 320 may be configured to initiate an omnispectrum LED grow light intensity adjustment method as outlined above. In summary, an omnispectrum LED grow light intensity adjustment method may comprise receiving a setting selection from the UI 200, automatically retrieving from memory 330 a corresponding set of intensity values, and automatically applying the retrieved set of intensity values to a plurality of the intensity adjustment mechanisms 340.

In FIG. 3, the controller 120 may be configured to automatically and simultaneously control the multiple intensities of the omnispectrum LED grow light, e.g., intensities at the first and second wavelengths, as well as any other wavelengths provided by the omnispectrum LED grow light. Simultaneous control, as defined herein, comprises both true simultaneous control and substantially simultaneous control. True simultaneous control comprises communicating with the various intensity adjustment mechanisms 340 at a same time, so that each of the wavelengths of the LED grow light are adjusted at the same time. Substantially simultaneous control comprises communicating with the various intensity adjustment mechanisms 341, 342, and 343 serially, but nonetheless automatically, in sequence and at high speed such that the various wavelengths of the LED grow light are adjusted substantially simultaneously. In alternative embodiments, the various wavelengths of the LED grow light may be adjusted serially and at a slow rate, e.g., one per second, which is perceptible by the human observer, to implement serial wavelength adjustment.

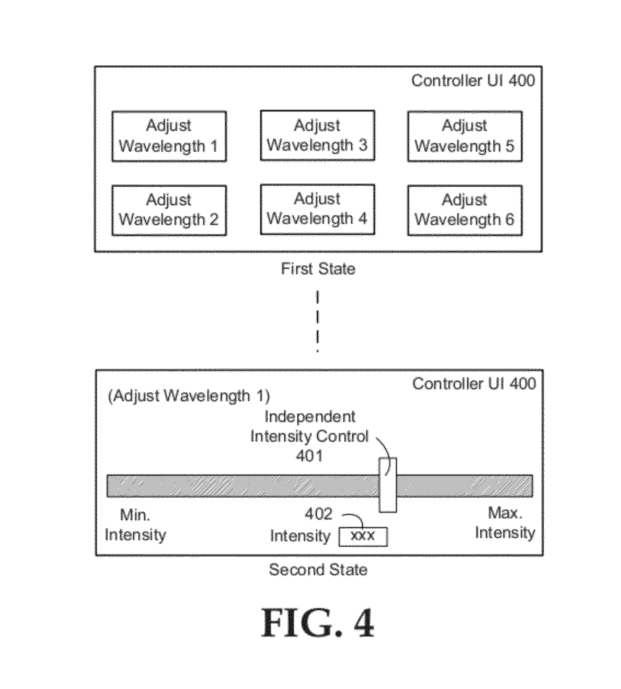

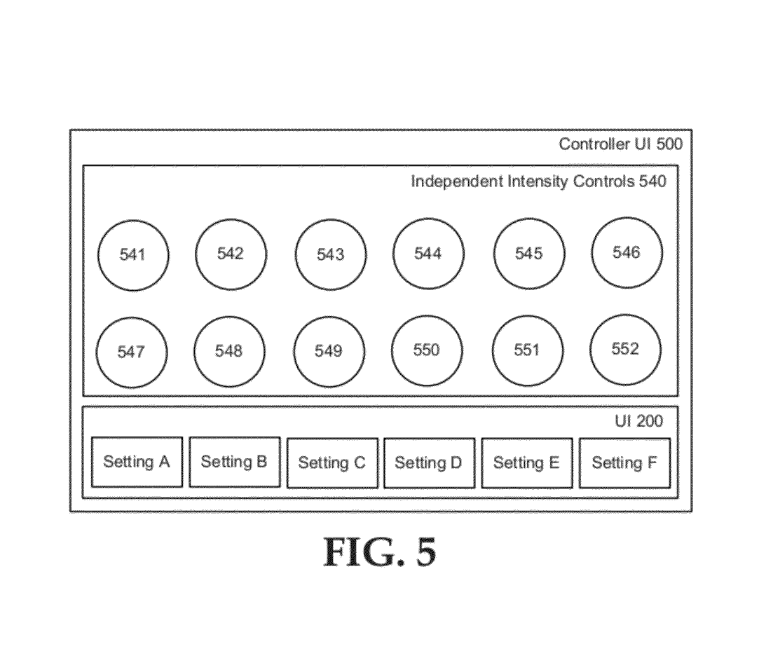

FIG. 4 and FIG. 5 illustrate additional example controller UI for an omnispectrum LED grow light. The UI embodiments illustrated in FIG. 4 and FIG. 5 allow for independent adjustment of single intensities of an omnispectrum LED grow light, without automatically also adjusting the intensities of other wavelengths provided by the light. In some embodiments, an intensity of any of the LED types illustrated in TABLE 1 may be independently adjustable in an omnispectrum LED grow light according to this disclosure. In some embodiments, intensities of two, three, four, five, or more different wavelengths, up to the twelve wavelengths illustrated in TABLE 1, and optionally additional wavelengths if more wavelengths are provided in a particular omnispectrum LED grow light, may be independently adjustable in an omnispectrum LED grow light according to this disclosure. In some embodiments, an omnispectrum LED grow light may be configured to include features for single intensity adjustment in addition to the multiple intensity adjustment approaches described herein. In some embodiments, an omnispectrum LED grow light may be configured to include features for single intensity adjustment, without also including the multiple intensity adjustment approaches described herein. Of course, some embodiments may also comprise the multiple intensity adjustment approaches, without single intensity adjustment features.

FIG. 4 illustrates an example controller UI 400 for an omnispectrum LED grow light configured to allow independent adjustment of a single intensity implemented in the light. A first state of controller UI 400 may comprise a plurality of selectable elements, such as “adjust wavelength 1”, “adjust wavelength 2”, “adjust wavelength 3”, and so on, for each of the adjustable wavelengths implemented in the omnispectrum LED grow light.

The UI 400 may be configured to enter the second state upon selection of an element presented in the first state. For example, the UI 400 may enter the illustrated second state for adjusting wavelength 1, when the “adjust wavelength 1” element is selected from the first state.

A second state of controller UI 400 may comprise an independent intensity control 401, for adjusting the intensity of the wavelength selected from the first state. The selected wavelength may be adjusted anywhere from a minimum intensity to a maximum intensity. Adjusting the intensity of the selected wavelength from the second state of the UI 400 may be independent, in that it may not affect the intensities of the other wavelengths provided by the grow light. In some embodiments, the minimum intensity may be off (no light emitted) while the max intensity may be the maximum safe intensity of the LED elements of the selected wavelength. The present intensity level of a wavelength adjustable via the UI 400 in the second state may also be displayed in an element 402.

The UI 400 may couple to a controller 120 as illustrated in FIG. 3. The UI 400 may be coupled to the processor 320 similar to UI 200. Processor 320 may be configured to adjust an intensity adjustment mechanism such as 341, 342, or 343 in response to adjustment information received from UI 400. For example, an independent intensity control 401 position may be transmitted to processor 320, and processor 320 may be configured to convert the position information to an intensity value, package the intensity value in an intensity adjustment control signal, and send the intensity adjustment control signal to an intensity adjustment mechanism corresponding to the wavelength being adjusted in the second state of controller UI 400.

FIG. 5 illustrates an example controller UI 500 for an omnispectrum LED grow light configured to allow independent adjustment of a single intensity implemented in the light. FIG. 5 illustrates a controller UI 500 comprising independent intensity controls 540. Independent intensity controls 540 include a plurality of adjustable dials 541-552. The adjustable dials 541-552 are another embodiment of independent intensity control. Each of the adjustable dials 541-552 may independently adjust intensity of one of the LED types used by an omnispectrum LED grow light. Controller UI 500 may also include a UI 200, including a plurality of selectable settings as described herein.

Similar to the UI 400 of FIG. 4, the adjustable dials 541-552 of UI 500 may be configured to allow intensity adjustment of a wavelength of an omnispectrum LED grow light from a minimum intensity to a maximum intensity. In general, it should be recognized that any of the various UI elements described herein may be implemented in a variety of different ways as will be appreciated, and may be combined with any of the other UI elements described herein, or with other UI elements as suited for particular embodiments.

Also similar to FIG. 4, the UI 500 may couple to a controller 120 as illustrated in FIG. 3. The UI 500 may be coupled to the processor 320 similar to UI 200. Processor 320 may be configured to adjust an intensity adjustment mechanism such as 341, 342, or 343 in response to adjustment information received from UI 500. For example, UI 500 may be configured to transmit position information corresponding to one or more adjustable dials 541-552 to processor 320, and processor 320 may be configured to convert the position information to an intensity value, package the intensity value in intensity adjustment control signal(s), and send the intensity adjustment control signal(s) to one or more corresponding intensity adjustment mechanism(s).

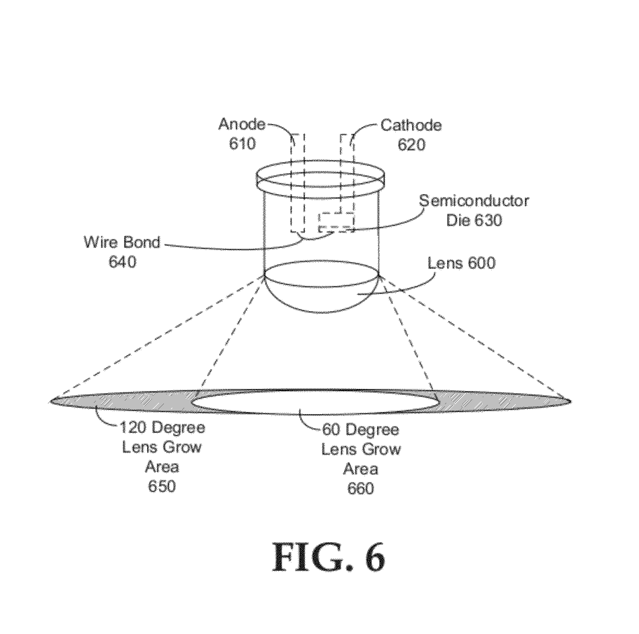

FIG. 6 illustrates an example LED element and example grow areas and corresponding intensities produced by an acute angle lens versus a wide angle lens. The LED element illustrated in FIG. 6 comprises a lens 600, an anode 610, a cathode 620, a semiconductor die 630 and a wire bond 640. The LED produces light by applying a potential difference across the semiconductor die 630 via the anode 610 and wire bond 640 and cathode 620. The potential difference causes the semiconductor die 630 to release light of a selected wavelength or wavelengths.

A wide angle lens is defined herein as a 120° or wider angle lens. A wide angle lens will cause an LED element to illuminate a grow area 650 at a first intensity level, while an acute angle lens, defined herein as a lens having an angle less than 120°, will cause an LED element to illuminate a grow area smaller than that illuminated by the 120° lens, with an intensity greater than the 120° lens. For example, a 60° lens will illuminate a grow area 660 with greater intensity than the 120° lens.

In some embodiments, an omnispectrum LED grow light may comprise LED elements of either or both of wide and acute angle lenses. In some embodiments, including LED elements of multiple differing lens types may be useful in achieving certain precise intensity levels desired for one or more wavelengths of an omnispectrum LED grow light.

While various embodiments have been disclosed herein, other aspects and embodiments will be apparent to those skilled in art.

1. An omnispectrum Light Emitting Diode (LED) grow light, comprising:
a plurality of LED elements of a first wavelength, arranged on a grow light surface;
a plurality of LED elements of a second wavelength, arranged on the grow light surface;
an intensity adjustment mechanism coupled to the plurality of LED elements of a first wavelength, and configured to adjust the intensity of the LED grow light at the first wavelength;
an intensity adjustment mechanism coupled to the plurality of LED elements of a second wavelength, and configured to adjust the intensity of the LED grow light at the second wavelength;
a controller coupled to the intensity adjustment mechanisms and configured to automatically control intensities of the LED grow light at the first and second wavelengths;
the controller comprising a plurality of settings corresponding to a plurality of plant types and/or plant growth phases, so that selection of a setting from the plurality of settings automatically adjusts the intensities of the LED grow light at the first and second wavelengths to optimal intensity levels for the plant type and/or growth phase corresponding to the selected setting.

2. The omnispectrum LED grow light of claim 1, further comprising a User Interface (UI) coupled to the controller and configured to allow user selection of a setting from the from the plurality of settings.

3. The omnispectrum LED grow light of claim 1, wherein the first wavelength and second wavelength comprise two or more of a 420 nanometer (nm), 440 nm, 450 nm, 460 nm, 470 nm, 612 nm, 630 nm, 640 nm, 660 nm, 670 nm, 740 nm, 4500 Kelvin (K) wavelength type.

4. The omnispectrum LED grow light of claim 1, wherein the controller is configured to simultaneously adjust the intensities of the LED grow light at the first and second wavelengths.

5. The omnispectrum LED grow light of claim 1, wherein the controller is further configured to independently adjust the intensities of the LED grow light at the first and second wavelengths by adjusting the intensity of the LED grow light at either the first or second wavelength, without adjusting the intensities of other wavelengths provided by the LED grow light.

6. The omnispectrum LED grow light of claim 1, wherein the LED elements included in the grow light are grouped into one or more light engines.

7. An omnispectrum Light Emitting Diode (LED) grow light, comprising:
a plurality of LED elements of a first wavelength, arranged on a grow light surface;
a plurality of LED elements of a second wavelength, arranged on the grow light surface;
wherein the first wavelength and second wavelength comprise two or more of a 420 nanometer (nm), 440 nm, 450 nm, 460 nm, 470 nm, 612 nm, 630 nm, 640 nm, 660 nm, 670 nm, 740 nm, 4500 Kelvin (K) wavelength type;
an intensity adjustment mechanism coupled to the plurality of LED elements of a first wavelength;
an intensity adjustment mechanism coupled to the plurality of LED elements of a second wavelength;
a controller coupled to the intensity adjustment mechanisms, the controller providing a User Interface (UI) configured to allow independent user adjustment of at least one single intensity of the LED grow light, without adjusting the intensities of other wavelengths provided by the LED grow light.

8. The omnispectrum LED grow light of claim 7, wherein the controller is further configured to automatically adjust multiple intensities of the LED grow light.

9. The omnispectrum LED grow light of claim 8, wherein the controller is configured to simultaneously adjust the multiple intensities of the LED grow light.

10. The omnispectrum LED grow light of claim 7, wherein the LED elements included in the grow light are grouped into one or more light engines.
